(19) United States
(12) Patent Application Publication
(10) Pub. No.: US 2010/0309283 A1
(43) Pub. Date: Dec. 9, 2010

(54) Portable Remote Audio/Video Communication Unit

(76) Inventor: Rodney A. Kuchar, JR., Pearland, TX (US)

Correspondence Address: BURLESON COOKE L.L.P., 2040 NORTH LOOP 336 WEST, SUITE 123, CONROE, TX, 77304, US

(21) Appl. No.: 12/480,487

(22) Filed: Jun. 8, 2009

(51) Int. Cl. H04N 7/14

(52) U.S. Cl. 348/14.02; 348/E07.078

(57) ABSTRACT

A lightweight, portable, audio/video communication unit is provided. The unit can be operated in remote areas for gathering high quality audio/video information and communicating the information back to a central reviewing area utilizing landline connections, a broadband communication network or a satellite network.

### BACKGROUND OF INVENTION

1. Field of the Invention

This invention relates to the transmission of audio/video information from remote locations throughout the world in real time to a conventional display device located wherever a landline, broadband or satellite transmission can be established.

2. Description of Related Art

Prior portable devices to transmit audio/video signals have been characterized by several drawbacks. These include poor visual quality, limited broadcast capability, lack of reliability and limited transmission time using battery power. The present invention overcomes these difficulties by broadcasting high-quality live video, up to a full screen, in real time. The unit will automatically connect to available transmission links, land line, broadband, or satellite, and provide an indication of which link is in use.

The device is completely portable, lightweight (approximately 6 pounds), self-contained and housed in a rugged casing for use in remote locations.

### BRIEF SUMMARY OF THE INVENTION

The present invention is a portable audio/video communication device that permits live broadcast of data from remote areas of the world to any given location that is capable of receiving data over landline, broadband, or satellite. The unit broadcasts high quality video, up to a full screen, in real time, utilizing a sub 256K stream. The network can be utilized to establish a mixture of data, video or audio connections depending on the required configuration. The unit will automatically connect to available transmission links. The components have been designed for minimal power usage so that the internal batteries are sufficient to provide at least 20 hours of operation between charges.

### BRIEF DESCRIPTION OF THE SEVERAL VIEWS OF THE DRAWING(S)

FIG. 1 is a flow chart of the various functions of the remote unit.

FIG. 2 is a flow chart of the functionality of the power control module.

FIG. 3 is a flow chart of the functionality of the switch controller.

### DETAILED DESCRIPTION OF THE INVENTION

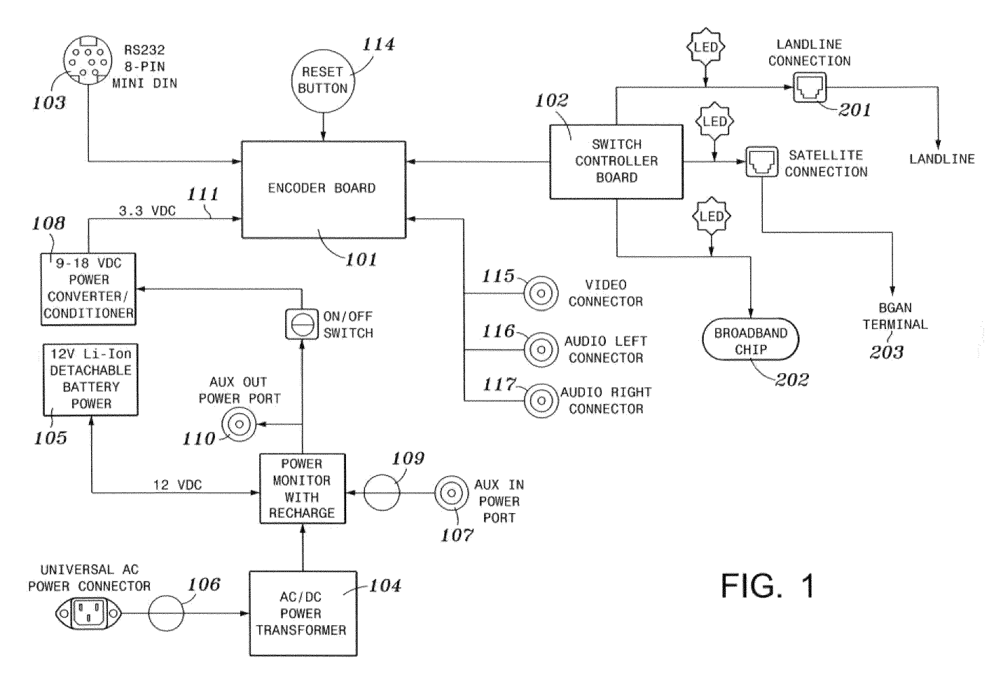

Referring to FIG. 1, the remote unit includes a Video Encoder Board (VEB) 101, a Switch Controller Board (SC) 102 that includes the power supply assembly, the power control module, and the circuitry for automatically detecting and connecting to either a landline, a broadband connection, or to a satellite link.

The Video Encoder Board 101 is the TX151 board manufactured by XVD Corporation which is embodied in the XVD enterprise SD-TX150 video and audio encoder manufactured by XVD Corporation. The board is built to PC104 standards. The encoder board firmware is based on XVD™ codec technology as disclosed in the following patents, the contents of which are expressly incorporated herein: U.S. Pat. Nos. 5,539,836; 5,602,961; 5,642,438; 5,659,659; 5,729,655; 5,818,535; 5,832,443; 6,249,614; 6,263,312; 6,339,616; 6,418,240; 6,952,671; 6,954,501; 6,965,859; 6,973,127; 7,181,404. The Video Encoder Board (VEB) includes a RS232 8-pin mini DIN two-way data port 103. The Video Encoder Board (VEB) also includes a programmable codec component.

Also included are input connections 115, 116, and 117 for RCA type video and audio connectors, respectively. A reset button 114 is provided.

The Video Encoder Board delivers high-resolution real-time digital video content across IP-based networks, providing the highest quality content at any given bandwidth, at full D1 resolution (525/30 or 625/50 lines/fps) within a single T1 link. It captures, encodes and compresses audio and video from any analog composite source (NTSC or PAL). Encoded data rates range from 50 Kbps for limited-bandwidth applications (such as BGAN) up to 2.2 Mbps where bandwidth is less constrained. Resolutions from QCIF to D1 and frame rates from 1 to 30 fps are supported.

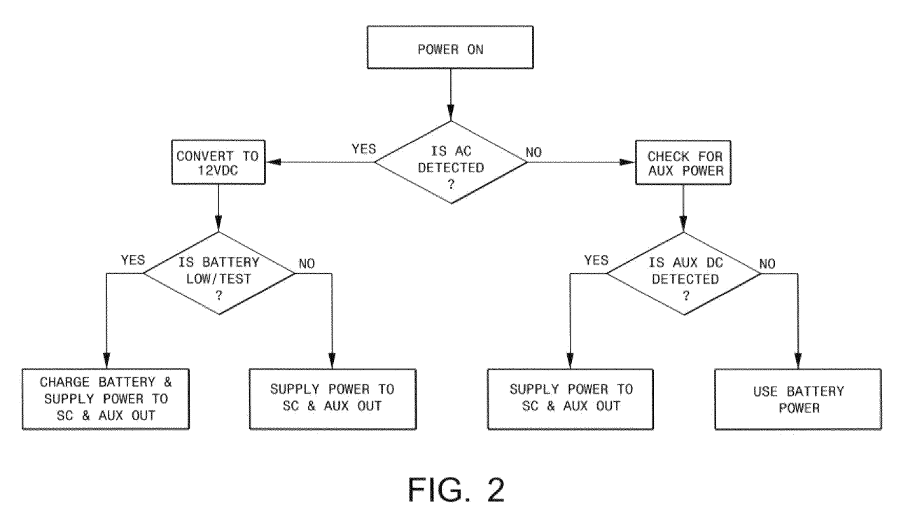

Power is sent from its source to a Power Control Module (PCM) on the SC. When activated, the PCM senses incoming power and decides the source to power the operation of the SC. The operation is described in FIG. 2.

If AC power is detected, the AC/DC power transformer 104 converts the AC power to DC power and sets the appropriate DC voltage and amperage for the SC. If AC power input is detected, the PCM tests the level of the internal 12 v DC batteries 105. If the batteries are below their capacity, the PCM begins to charge the batteries. The PCM constantly monitors the charging and terminates the charge when it reaches capacity. The PCM is protected by a breaker 106 from the external AC power source.

If DC power is detected by the PCM through the 12 v DC power input 107 on the instrument face, the PCM will test the power and, if acceptable, utilize the 12 v DC source. The 12 v DC power is stepped down by the power converter/conditioner 108 to the DC voltage and amperage for the SC to about 3.3 v DC. If external DC power input is detected, the PCM tests the level of the internal 12 v DC batteries. If the batteries are below their capacity, the PCM begins to charge the batteries. The PCM constantly monitors the charging and terminates the charge when it reaches capacity. The PCM is protected by a breaker 109 from the external DC power source.

If both external AC and DC power is detected the AC will be utilized first.

If no AC power or external DC power is detected, the PCM draws power from the internal 12 v DC batteries. The 12 v DC power is stepped down to the DC voltage and amperage for the SC.

The PCM is equipped with an auxiliary power source to enable hot swapping of the internal 12 v DC batteries. The auxiliary power source provides power during changes between power sources.

The PCM provides and manages power to an external power supply port 110 on the instrument face. The external power supply is a 12 v 1-Amp supply. The PCM manages the power output. The PCM stops the flow to the external power supply if the batteries go below a set level.

The PCM provides power to the Video Encoder Board (VEB) through the SC at 111.

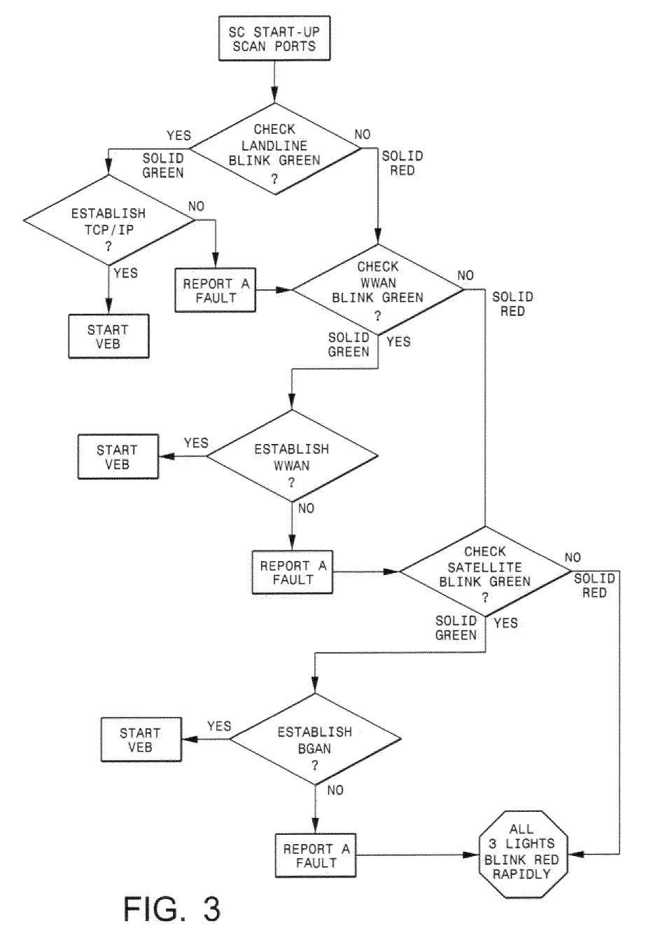

The Switch Controller (SC) provides the necessary functionality to manage the uplink connections. The various functions are shown and described in FIG. 3. It establishes a data connection to the Video Encoder Board 101 to transmit the data. It also provides simple status to the user to indicate which link is in use and whether it is operational, being activated, or in a fault state. The SC provides a remote diagnostic interface via the active link to perform such tasks as software updates, diagnostic download and other service-related capabilities.

The Switch Controller will identify which of the uplinks, ENET, WWAN or BGAN is active. The order of preference in choosing a connection is landline, WWAN, and then satellite.

For the landline, a standard TCP/IP connection 201 is used. DHCP is used to set the host IP parameters. The destination IP address/DNS name is included in the firmware.

For the WWAN, the software will control the Qualcom hardware broadband chip 202 located in the switch controller to make a connection to the WWAN network and then will establish a connection.

For the BGAN, the software will control the BGAN connection protocol and then will establish a connection. A suitable BGAN component 203 is the Model 9201, sold by Hughes.

Once a connection is established, the software will begin transferring data using a standard protocol such as TCP/IP or RTP/RTCP or other streaming protocol. The chosen protocol will be a standard that is generally available for the operating system.

Once a connection is established, a method to break the data connection so that the remote system can take console control of the Switch Controller is provided. This is to permit remote diagnostics, reboot/reset and the possibility of remotely uploading software updates to both the SC and the encoder board through data port 103. This also utilizes a piece of code on the SC that will provide remote console control of the encoder.

RJ45 Cat 5 Ethernet connectors are provided on the unit for ENET or BGAN connections. Tyco™ 2-111196-5 connectors on the encoder board 101 are used for inputs from the data port 103, and the audio/video inputs 115, 116, 117 via 10 wire 30-32 AWG ribbon cable. A 10 wire 30-32 AWG ribbon cable is connected to the encoder board 101 and the switch controller board 102.

Although the present invention has been described with respect to specific details, it is not intended that such details should be regarded as limitations on the scope of the invention, except to the extent that they are included in the accompanying claims.

I claim:

1. A portable, remote audio/video communication unit comprising a housing containing:
a power input for connection to a power source;
a video/audio encoder board;
inputs for audio and video signals to the video/audio encoder board; and
a switch controller coupled to the video/audio encoder board for connecting the output of the video/audio board to a selected communication network.

2. The device according to claim 1 wherein the switch controller has output connections for a landline network, a WWAN network, and a satellite network.

3. The device according to claim 2 wherein the switch controller senses the availability of the networks, and automatically connects to one of the available networks.

4. The device according to claim 3 wherein the priority of connection is in the order of landline, WWAN, and satellite.

5. The device according to claim 1 wherein the input for a power source includes an input from a conventional power grid and a battery source.

6. The device according to claim 5 wherein the battery source is a 12V lithium ion source.

7. The device according to claim 6 including a power control module, the module sensing where AC power is present, and transforming the AC power to DC power.

8. The device according to claim 7 wherein the power control module senses the power level of the batteries, and charges the batteries if they are below their capacity.

9. The device of claim 1 including a two-way data port for the encoder board.

10. The device of claim 9 including a programmable codec component mounted on the encoder board.

11. The device of claim 1 wherein the video encoder board transmits data at the rate of at least 256 KBS.
